(19) United States
(12) Patent Application Publication
(10) Pub. No.: US 2010/0039907 A1
(43) Pub. Date: Feb. 18, 2010

(54) OPTICAL DISK DEVICE

(75) Inventors: Hirokazu Shou, Tokyo (JP); Hideshi Ohue, Kanagawa-ken (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/236,923

(22) Filed: Sep. 24, 2008

(30) Foreign Application Priority Data
Sep. 27, 2007 (JP) 2007251656

(51) Int. Cl. G11B 19/00

(52) U.S. Cl. 369/47.5; G9B/19; 369/100

(57) ABSTRACT

An optical disk device includes a first control circuit controlling a light quantity of a semiconductor laser according to a first light quantity set value corresponding to a first light quantity resolution; a second control circuit controlling the light quantity of the semiconductor laser according to a second light quantity set value corresponding to a second light quantity resolution that is smaller than the first light quantity resolution; and a drive circuit driving the semiconductor laser following the first and second control circuits.

### CROSS-REFERENCE TO RELATED APPLICATIONS

This application is based upon and claims the benefit of priority from the prior Japanese Patent Application No. 2007-251656, filed on Sep. 27, 2007; the entire contents of which are incorporated herein by reference.

### BACKGROUND OF THE INVENTION

1. Field of the Invention

The present invention relates to an optical disk device recording and reproducing data on/from an optical disk.

2. Description of the Related Art

An optical disk device is used which records and reproduces data on/from an optical disk. Light is controlled in quantity and applied to the optical disk in accordance with each of the time of recording and the time of reproducing (see, for example, JP-A 2005-203030 (KOKAI)).

### BRIEF SUMMARY OF THE INVENTION

When the difference between light quantities at the time of recording and at the time of reproducing is large, it is not always easy to accurately control both of them. In other words, it is not always easy to realize the compatibility of the resolution and the dynamic range of the light quantity. An object of the present invention is to provide an optical disk device in which the compatibility of the resolution and the dynamic range of the light quantity is realized.

An optical disk device according to one aspect of the present invention includes a semiconductor laser applying a laser beam to an optical disk; a first control circuit controlling a light quantity of the semiconductor laser according to a first light quantity set value corresponding to a first light quantity resolution; a second control circuit controlling the light quantity of the semiconductor laser according to a second light quantity set value corresponding to a second light quantity resolution that is smaller than the first light quantity resolution; and a drive circuit driving the semiconductor laser following the first and second control circuits.

### BRIEF DESCRIPTION OF THE DRAWINGS

FIG. 1 is a block diagram showing an optical disk device according to an embodiment of the present invention.

FIG. 2 is a block diagram showing the internal configuration of a laser control circuit.

FIG. 3 is a flowchart showing one example of the operation procedure of the optical disk device.

### DETAILED DESCRIPTION OF THE INVENTION

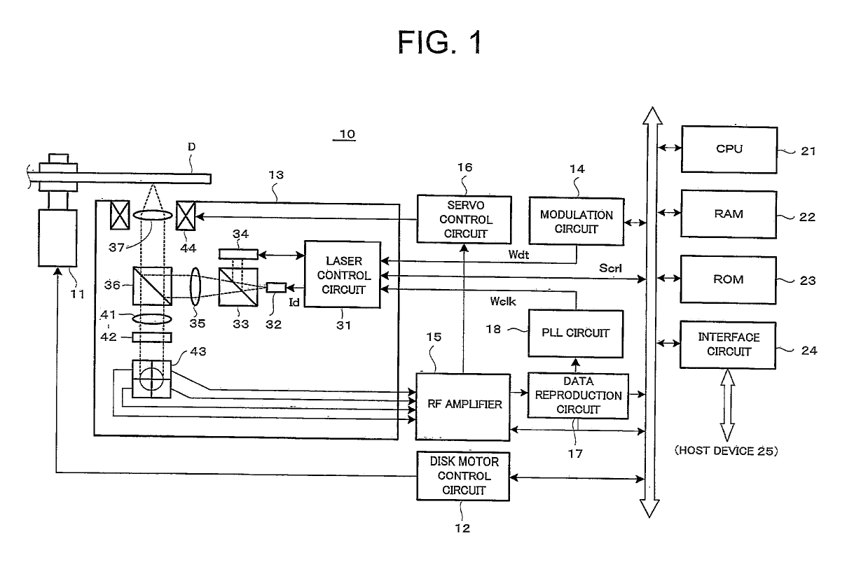

Hereinafter, embodiments of the present invention will be described with reference to the drawings. FIG. 1 is a block diagram showing an optical disk device 10 according to an embodiment of the present invention. The optical disk device 10 records and reproduces information on/from an optical disk D.

The optical disk D is an information storage medium such as, for example, a DVD (Digital Versatile Disc), an HD-DVD, or the like. The optical disk D has a groove in a concentric form, or a spiral form. One round of the groove is called a track. Laser beam which has been modulated in intensity is applied along the track to form marks (pits or the like), whereby user data is recorded. At the time of reproducing the data, laser beam weaker than that at the time of recording is applied along the track. By detecting changes in intension of reflected light from the marks on the track, the data is reproduced.

The optical disk D is rotationally driven by an optical disk motor 11. The optical disk motor 11 is controlled by an optical disk motor control circuit 12. An optical head 13 records and reproduces information on/from the optical disk D.

At the time of recording information (at the time of forming marks), user data is supplied from a host device 25 via an interface circuit 24 to a modulation circuit 14. The modulation circuit 14 performs EFM-modulation (for example, 8 to 14 modulation) on the user data and outputs it as a data signal Wdt to a laser control circuit 31.

Based on the data signal Wdt supplied from the modulation circuit 14, the laser control circuit 31 supplies a write current (a drive current Id) to a semiconductor laser (a laser diode) 32. In this event, a clock signal Wclk from a PLL circuit 18 and a control signal Scrl from a CPU 21 are used. At the time of reading information, the laser control circuit 31 supplies a read current (a drive current Id) smaller than the writing current to the semiconductor laser 32. Note that details of the laser control circuit 31 will be described later.

A photodetector (a front monitor) 34 detects the light quantity (the emission power) of the laser beam generated by the semiconductor laser 32 and supplies a light quantity detection current Ip to the laser control circuit 31.

Based on the detection current from the photodetector 34, the laser control circuit 31 controls the semiconductor laser 32. As a result, the semiconductor laser 32 emits light at a reproduction time-laser power and at a recording time-laser power which are set by the CPU 21.

The laser beam emitted from the semiconductor laser 32 is applied onto the optical disk D via a half prism 33, a collimator lens 35, a half prism 36, and an objective lens 37. The reflected light from the optical disk D is conducted to a photodetector 43 via the objective lens 37, the half prism 36, a condenser lens 41, and a cylindrical lens 42. The photodetector 43 is composed of, for example, four-split light detecting cells so that detection signals by the light detecting cells are outputted to an RF amplifier 15.

The RF amplifier 15 processes the signals from the light detecting cells to generate a focus error signal FE, a tracking error signal TE, and an RF signal. The focus error signal FE indicates the deviation (error) from just focus. The tracking error signal TE indicates the deviation (error) between the beam spot center of the laser beam and the track center. The RF signal is a signal made by adding all of the signals from the light detecting cells in which the reflection light from the mark formed on the track of the optical disk D is reflected. The RF signal is supplied to a data reproduction circuit 17, where data is reproduced.

The focus error signal FE and the tracking error signal TE are supplied to a servo control circuit 16, where a focus drive signal and a track drive signal are generated. The focus drive signal and the track drive signal are supplied to a drive coil 44 so that the objective lens 37 is moved in a focusing direction (a lens optical axis direction) and in a tracking direction (a direction perpendicular to the lens optical axis). As a result, focus servo (to always just focus the laser beam on the recording film of the optical disk D) and tracking servo (to keep the laser beam always tracing the track formed on the optical disk D) are carried out.

The CPU (Central Processing Unit) 21 comprehensively controls the optical disk device 10 following an operation command provided from the host device 25 via the interface circuit 24. The CPU 21 operates using a RAM (Random Access Memory) 22 as a work area and following a control program recorded on a ROM (Read Only Memory) 23.

The CPU 21 functions as the following 1) and 2).

1) A calculation unit calculating light quantity set values N1 and N2 (first and second light quantity set values).
2) A setting unit setting the light quantity set values N1 and N2 in an absolute light quantity control circuit 53 and a relative light quantity control circuit 54 (first and second control circuits), respectively.

For the ROM 23, a nonvolatile memory such as, for example, a flash memory can be used. The ROM 23 stores a first data indicating the relation between the light quantity set value N1 and a light quantity P of the semiconductor laser 32, and a second data indicating the relation between the light quantity set value N2 and the light quantity P of the semiconductor laser 32.

The first data can be composed of a plurality of combinations of the light quantity set value N1 and the light quantity P. The second data can be composed of a plurality of combinations of the light quantity set value N2 and the light quantity P. Alternatively, the first data may be composed of the combination of a light quantity resolution A1 (a first light quantity resolution) and a light quantity offset Bt. The first data may be composed of a light quantity resolution A2 (a second light quantity resolution).

### (Details of Laser Control Circuit 31)

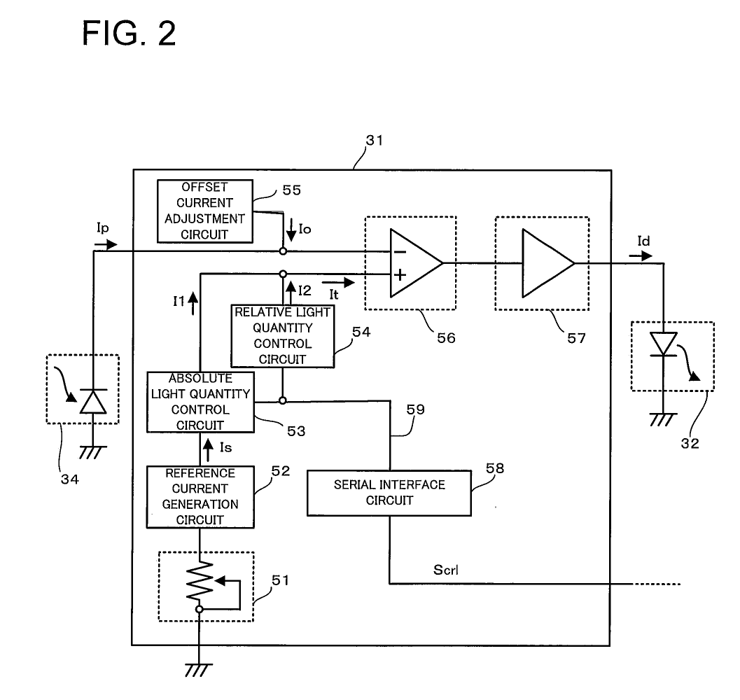

FIG. 2 is a block diagram showing the internal configuration of the laser control circuit 31. The laser control circuit 31 includes a variable resistor 51, a reference current generation circuit 52, the absolute light quantity control circuit 53, the relative light quantity control circuit 54, an offset current adjustment circuit 55, an error detection circuit 56, a laser drive circuit 57, and a serial interface circuit 58. In this drawing, a mechanism controlling the light quantity P of the semiconductor laser 32 is shown. Note that illustration of a mechanism modulating the semiconductor laser 32 is omitted.

The variable resistor 51 adjusts the light quantity resolution A1 of the absolute light quantity control circuit 53 by defining a reference current Is generated in the reference current generation circuit 52.

The reference current generation circuit 52 generates the reference current Is. The reference current Is is defined by the variable resistor 51 and is the reference of a light quantity setting current I1 to be outputted from the absolute light quantity control circuit 53.

The absolute light quantity control circuit 53 stores the light quantity set value (an absolute light quantity set value) N1, and outputs a light quantity setting current (an absolute light quantity setting current) I1 corresponding to the light quantity set value N1 and the reference current Is. The light quantity setting current I1 defines the drive current Id driving the semiconductor laser 32 and thus the light quantity P of the laser beam emitted from the semiconductor laser 32. Note that the light quantity setting current I1 is proportional to a light quantity P1 (=A1*N1+B1) expressed by later-described Expression (1).

The light quantity set value N1 is an integer number, for example, from 0 to a predetermined maximum value M1 (for example, 255). The light quantity set value N1 has a relation with the light quantity (intensity) P1 [mW] of the semiconductor laser 32 expressed by the following Expression (1). Note that the light quantity P1 is an element controlled by the absolute light quantity control circuit 53 in the total light quantity P of the semiconductor laser 32.

P1=A1*N1+B1 Expression (1)

A1: light quantity resolution [mW/dec]

B1: light quantity offset [mW]

The light quantity resolution A1 is defined by the variable resistor 51 and takes a value of, for example, 0.1 [mW/dec].

The relative light quantity control circuit 54 stores the light quantity set value (a relative light quantity set value) N2 and outputs a light quantity setting current (a relative light quantity setting current) I2 corresponding to the light quantity set value N2. The light quantity setting current I2 defines the drive current Id driving the semiconductor laser 32 and thus the light quantity P of the laser beam emitted from the semiconductor laser 32. Note that the light quantity setting current I2 is proportional to a light quantity P2 (=A2*N2+B2) expressed by later-described Expression (2).

The light quantity set value N2 is an integer number, for example, from 0 to a predetermined maximum value M2 (for example, 63). The light quantity set value N2 has a relation with the light quantity (intensity) P2 [mW] of the semiconductor laser 32 expressed by the following Expression (2). Note that the light quantity P2 is an element controlled by the relative light quantity control circuit 54 in the total light quantity P of the semiconductor laser 32.

P2=A2*N2+B2 Expression (2)

A2: light quantity resolution [mW/dec]

B2: light quantity offset [mW]

The light quantity resolution A2 takes a value smaller than that of the light quantity resolution A1.

The total light quantity P of the semiconductor laser 32 is expressed by the following Expression (3).

$$\begin{matrix}P = P 1 + P 2 \\ = A 1 * N 1 + B 1 + A 2 * N 2 + B 2 \\ = A 1 * N 1 + A 2 * N 2 + Bt\end{matrix} \\ Bt ( = B 1 + B 2 ) \text{:} total light quantity offset \qquad Expression ( 3 )$$

The respective values of the light quantity offsets B1 and B2 are not required in considering the total light quantity P of the laser beam. From this viewpoint, in place of Expressions (1) and (2), the following Expressions (4) and (5) can be used.

P1=A1*N1+Bt Expression (4)

P2=A2*N2 Expression (5)

Because the light quantity resolution A2 is smaller than the light quantity resolution A1, the light quantity set values N1 and N2 can be respectively used for rough adjustment and fine adjustment of the light quantity. By combining the absolute light quantity control circuit 53 and the relative light quantity control circuit 54, the compatibility of the resolution and the dynamic range of the light quantity P is realized.

Note that the relative light quantity control circuit 54 may have a smaller variation range than that of the absolute light quantity control circuit 53. Further, the maximum value M2 of the light quantity set value N2 may be smaller than the maximum value M1 of the light quantity set value N1. The light quantity set values N1 and N2 can be expressed by relatively smaller number of bits.

The offset current adjustment circuit 55 is connected in parallel with the photodetector 34 and outputs an offset adjustment current Io. The offset adjustment current Io is for canceling the offset currents of the absolute light quantity control circuit 53 and the relative light quantity control circuit 54. The above-described light quantity offsets B1, B2, and Bt are generated by the offset currents and so on which could not been sufficiently canceled due to an error or the like of the offset adjustment current Io.

The error detection circuit 56 compares the light quantity detection current Ip from the photodetector 34 with a light quantity setting current It (the total sum of the light quantity setting currents I1 and I2, It=I1+I2) and outputs a laser drive circuit control signal to the laser drive circuit 57 so that the difference between them is 0 (so that the light quantity detection current Ip is equal to the light quantity setting current It).

The laser drive circuit 57 amplifies the laser drive circuit control signal outputted from the error detection circuit 56 and outputs the drive current Id to drive the semiconductor laser 32. This results in that the light quantity P from the semiconductor laser 32 is defined by Expression (3).

The serial interface circuit 58 sets the light quantity set values N1 and N2 of the absolute light quantity control circuit 53 and the relative light quantity control circuit 54 by the control signal Scrl from the CPU 21. The serial interface circuit 58 is connected, for example, by a 4-bit data bus 59 with the absolute light quantity control circuit 53 and the relative light quantity control circuit 54.

### (Operation Procedure of Optical Disk Device 10)

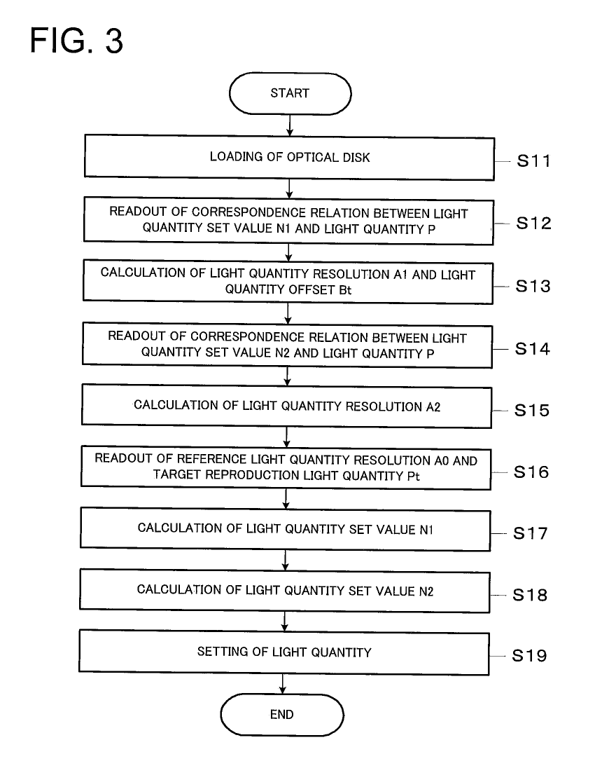

The operation procedure of the optical disk device 10 will be described. FIG. 3 is a flowchart showing one example of the operation procedure of the optical disk device 10.

### (1) Loading of Optical Disk D (Step S11)

The optical disk D is loaded into the optical disk device 10. The CPU 21 controls the optical head 13 to read from the optical disk D information for identifying the optical disk (disk type information).

(2) Readout of Correspondence Relation between Absolute Light Quantity Set Value N1 and Light Quantity P (Step S12)

The CPU 21 reads out from the ROM 23 the data indicating the correspondence relation between the light quantity set value N1 and the light quantity P. For example, a plurality of sets of the light quantity set value N1 and the light quantity P of the semiconductor laser 32 at the time of the light quantity set value N1 are read out. The number of sets can be 3 or greater. As the number is increased, the accuracy of controlling the light quantity P is improved.

Note that these sets are obtained by measuring the light quantity P with the relative light quantity set value N2 being set to an arbitrary fixed value, for example, a minimum (0) and the light quantity set value N1 being varied. It is preferable to store in the ROM 23 the set of the light quantity set value N1 and the light quantity P measured at the manufacture of the optical disk device 10.

### (3) Calculation of Absolute Light Quantity Resolution A1 and Light Quantity Offset Bt (Step S13)

The CPU 21 calculates the light quantity resolution A1 and the light quantity offset Bt, for example, by the least square method from the plurality of sets of the light quantity set value N1 and the light quantity P. In this event, Expression (4) is used. Calculation of the light quantity resolution A1 and the light quantity offset B1 allows accurate control to a target reproduction light quantity Pt (for example, responds to adjustment variations of the variable resistor 51 determining the light quantity resolution A1 of the absolute light quantity control circuit 53).

(4) Readout of Correspondence Relation between Relative Light Quantity Set Value N2 and Light Quantity P (Step S14)

The CPU 21 reads out from the ROM 23 the data indicating the correspondence relation between the light quantity set value N2 and the light quantity P. For example, a plurality of sets of the light quantity set value N2 and the light quantity P of the semiconductor laser 32 at the time of the light quantity set value N2 are read out. The number of sets can be 3 or greater. As the number is increased, the accuracy of controlling the light quantity P is improved.

Note that these sets are obtained by measuring the light quantity P with the absolute light quantity set value N1 being set to an arbitrary fixed value, for example, a minimum (0) and the light quantity set value N2 being varied. It is preferable to store in the ROM 23 the set of the light quantity set value N2 and the light quantity P measured at the manufacture of the optical disk device 10.

### (5) Calculation of Relative Light Quantity Resolution A2 (Step S15)

The CPU 21 calculates the light quantity resolution A2, for example, by the least square method from the plurality of sets of the light quantity set value N2 and the light quantity P. In this event, Expression (5) is used. Calculation of the light quantity resolution A2 allows accurate control to a target reproduction light quantity Pt. Unlike the above description, it is not necessary to concern the light quantity offset B2 of the relative light quantity control circuit 54.

### (6) Readout of Reference Light Quantity Resolution A0 and Target Reproduction Light Quantity Pt (Step S16)

The CPU 21 reads out from the ROM 23 the reference light quantity resolution A0 and the target reproduction light quantity Pt.

The reference light quantity resolution A0 is a reference value (a design value (an ideal value)) of the light quantity resolution A1 of the absolute light quantity control circuit 53, and optical disk devices 10 of the same type will have a common value (the light quantity resolution A1 is individually measured for each optical disk device 10). From outside the laser control circuit 31, the light quantity P appears to be controlled according to the reference light quantity resolution A0.

The target reproduction light quantity Pt is the light quantity targeted when the data is reproduced from the optical disk D. The target reproduction light quantity Pt differs depending on the type of the optical disk device D and is thus stored corresponding to the disk type information in the ROM 23.

### (7) Calculation of Absolute Light Quantity Set Value N1 (Step S17)

Using the following Expression (6), the CPU 21 calculates the absolute light quantity set value N1 [dec] from the reference light quantity resolution A0 and the target reproduction light quantity Pt. Note that the absolute light quantity set value N1 is an integer number, and therefore the value after the decimal point is rounded down.

Pt=A0*N1 Expression (6)

### (8) Calculation of Relative Light Quantity Set Value N2 (Step S18)

Using the following Expression (7), the CPU 21 calculates a light quantity error Perr [mW] from the light quantity resolution A1, the light quantity offset Bt, and the absolute light quantity set value N1.

Perr=Pt−(A1×N1+Bt) Expression (7)

Using the following Expression (8), the CPU 21 calculates the relative light quantity set value N2 from the light quantity error Perr. Note that the relative light quantity set value N2 is an integer number, and therefore the value after the decimal point is rounded down or up. Whether the rounding down or the rounding up is employed is determined depending on the relation between the relative light quantity set value N2 and the light quantity error Perr. In other words, the rounding up or the rounding down is employed which provides a value closer to the light quantity error Perr when the relative light quantity set value N2 is substituted into Expression (8).

Perr=A2*N2 Expression (8)

### (9) Setting of Light Quantity P (Step S19)

The CPU 21 sets the light quantity P of the semiconductor laser 32. More specifically, the light quantity set values N1 and N2 are stored (set) in the absolute light quantity control circuit 53 and the relative light quantity control circuit 54. As a result, the semiconductor laser 32 emits the laser beam of the light quantity P according to the light quantity set values N1 and N2.

The following advantages (1) to (3) are available in this embodiment.

### (1) Compatibility of Dynamic Range and Resolution of Light Quantity P

By combining the absolute light quantity control circuit 53 and the relative light quantity control circuit 54 which have different light quantity resolutions A1 and A2, the variation range (dynamic range) and the accuracy (resolution) of the light quantity P are compatible. As a result, even when the difference between a light quantity Pw at the time of recording and a light quantity Pr at the time of reproducing is large, both the light quantities Pw and Pr can be accurately controlled. For example, when the light quantity Pr at the time of reproducing is relatively small of 0.5 [mW], the light quantity Pr can be accurately controlled without fining the light quantity resolution A1 of the absolute light quantity control circuit 53.

It is assumed that the target reproduction light quantity Pt is 0.5 [mW] and the light quantity resolution A1 is 0.1 [mW/dec]. In this case, the variation of the light quantity P when the light quantity set value N1 is varied by one is 20[%] of the target reproduction light quantity Pt. In other words, fine adjustment of the light quantity P is difficult.

The absolute light quantity control circuit 53 can deal with a small reproduction light quantity here by fining the light quantity resolution A1. However, the maximum light quantity (the light quantity Pw at the time of recording) when setting the light quantity set value N1 of the absolute light quantity control circuit 53 is decreased. If the number of bits of the light quantity set value N1 is increased, compatibility of the dynamic range and the resolution of the light quantity P is possible, but the internal configuration of the absolute light quantity control circuit 53 and so on becomes complicated.

Combining the absolute light quantity control circuit 53 and the relative light quantity control circuit 54 as described above allows compatibility of the variation range and the accuracy of the light quantity P without increasing the number of bits of the light quantity set value N1.

### (2) Reduction in Variations of Recording and Reproducing Performances in Each Optical Disk Device 10

Using the correspondence relation between the light quantity set values N1 and N2 and the light quantity P measured for each optical disk device apparatus 10, the light quantity P is controlled. As a result, variations in the light quantity P in each optical disk device 10 and thus variations in the recording and reproducing performances of the optical disk device 10 are reduced. Note that it is also possible to store, as the correspondence relation, the light quantity resolutions A1 and A2 and the light quantity offset Bt themselves in the ROM 23. This eliminates the calculation of the light quantity resolutions A1 and A2 and the light quantity offset Bt.

### (3) Only one Adjustment of Light Quantity Offset

As has been described, it is only necessary in this embodiment to consider only the total sum Bt of the light quantity offsets B1 and B2 of the absolute light quantity control circuit 53 and the relative light quantity control circuit 54. It is unnecessary to individually adjust the light quantity offsets B1 and B2.

### OTHER EMBODIMENTS

The embodiment of the present invention is not limited to the above-described embodiment but can be extended and modified. The extended and modified embodiments are also included in the technical scope of the present invention.

What is claimed is:

1. An optical disk device, comprising:
a semiconductor laser applying a laser beam to an optical disk;
a first control circuit controlling a light quantity of the semiconductor laser according to a first light quantity set value corresponding to a first light quantity resolution;
a second control circuit controlling the light quantity of the semiconductor laser according to a second light quantity set value corresponding to a second light quantity resolution that is smaller than the first light quantity resolution; and
a drive circuit driving the semiconductor laser following the first and second control circuits.

2. The optical disk device as set forth in claim 1,
wherein the first control circuit outputs a first current corresponding to a product of the first light quantity resolution and the first light quantity set value,
the second control circuit outputs a second current corresponding to a product of the second light quantity resolution and the second light quantity set value, and
the drive circuit drives the semiconductor laser corresponding to a sum of the first and second currents.

3. The optical disk device as set forth in claim 1, further comprising:
a storage unit storing first data indicating a relation between the first light quantity set value and the light quantity of the semiconductor laser, and second data indicating a relation between the second light quantity set value and the light quantity of the semiconductor laser;
a calculation unit calculating the first and second light quantity set values based on the first and second data and a target light quantity; and
a setting unit setting the calculated first and second light quantity set values in the first and second control circuits, respectively.

4. The optical disk device as set forth in claim 3,
wherein the calculation unit includes:
a first calculation unit calculating the first light quantity resolution and a light quantity offset from the first data; and
a second calculation unit calculating the second light quantity resolution from the second data.

5. The optical disk device as set forth in claim 4,
wherein the calculation unit further includes:
a third calculation unit calculating the first light quantity set value from the first light quantity resolution, the light quantity offset, and the target light quantity; and
a fourth calculation unit calculating the second light quantity set value from the first and second light quantity resolutions, the light quantity offset, the target light quantity, and the calculated first light quantity set value.

6. The optical disk device as set forth in claim 3,
wherein the first data is a plurality of combinations of the first light quantity set value and the light quantity, and
the second data is a plurality of combinations of the second light quantity set value and the light quantity.

7. The optical disk device as set forth in claim 3,
wherein the first data is the first light quantity resolution and the light quantity offset, and
the second data is the second light quantity resolution.
